(19) United States
(12) Patent Application Publication
(10) Pub. No.: US 2017/0153167 A1
(43) Pub. Date: Jun. 1, 2017

(54) Vibrating Cell Strainer

(71) Applicant: Hans Werner Heinrich, Spring Valley, CA (US)

(72) Inventor: Hans Werner Heinrich, Spring Valley, CA (US)

(21) Appl. No.: 14/953,923

(22) Filed: Nov. 30, 2015

(51) Int. Cl. G01N 1/40; B01D 35/20; B01D 33/03

(52) U.S. Cl. CPC G01N 1/4077; B01D 33/03; B01D 35/20; G01N 2001/4088

(57) ABSTRACT

A cell strainer is described consisting of an integrated vibrating mechanism to prevent clogging up the mesh by larger components.

1

### FIELD OF THE INVENTION

This invention relates to research devices for particle separation through woven meshes or filter membranes.

### BACKGROUND OF THE INVENTION

Filtration of complex liquid samples through meshes of different mesh sizes or membranes of different pore sizes is a basic research tool in all biological and medical research fields. Particles of different sizes and a high protein concentration cause the problem of clogging up the pores especially for membrane filtration with pore sizes of less than 1 μm. Cascade filtration through membranes of decreasing pores sizes is one way to increase the filtration efficiency. Another commonly used method is to move the liquid constantly parallel to the filter membrane. The liquid to be filtrated has to be kept under overpressure.

The same physical principles are in operation for particle separation of much bigger sizes and by using filtration through woven meshes. Particle separation or particle sorting according to their size is a basic requirement for many scientific disciplines. The typically used so called “cell strainer” has found a wide application which has nothing to do with the straining of somatic cells. WO 1993001271 describes a strainer hanging inside a vessel. The small size of the filter/mesh area in devices for laboratory use is the result of practical laboratorial work. Only a limited amount of sample material is needed, all necessary other buffers and disposables are minimized, rack space is reduced, more samples can be handled parallel, and, at the end, costs are reduced.

EP2664367A1 describes a cell strainer which is compatible with tubes of different opening sizes, i.e. fits on at least both the standard 15 ml and 50 ml laboratory tubes. The strainer consists of two parts, an “upper portion” which is the original strainer, and a “lower portion” which is an adaptor between the strainer and the standard tubes. It is designed to fit into the openings of different sizes. The cell strainer according EP2664367A1 can be used for the removal of cell aggregates or large particles after tissue dissociation or from blood samples of up to 50 ml to obtain uniform single-cell suspensions.

All disclosed solutions work for certain fields of applications in biological or medical research, but they have no additional included mechanism which reduces or prevents the clogging up of the openings of the mesh.

A goal of the invention is to introduce an integrated part in these research tools which reduces the obstruction of the mesh openings by larger particles. This can be achieved by any movement of the liquid to be filtrated as described in U.S. Ser. No. 14/792,397. An additional mechanism is to keep the mesh and/or the whole device during the filtration process in vibration. This can be by accomplished by mounting a device on a vibrating platform or, by integrating a vibrating device in the filtration device.

### SUMMARY OF THE INVENTION

The present invention reveals a vibrating research device to filtrate or separate particles according to their size. The filtration performance is increased by the reduced blockage of the mesh openings by detritus. This is realized by a device which keeps the mesh and the liquid to be filtrated in vibration. This is achieved according to the invention, by integrating a vibrating device in the housing of the mesh. The vibrating device is a small vibration motor initially developed for massaging products. The vibration is the result of an eccentric rotating mass. Vibration frequency and amplitude is defined by rotation speed and the mass of the eccentric rotating axis.

### BRIEF DESCRIPTION OF THE FIGURES

FIG. 1 shows the schematic side view of a cell strainer with the vibrating device as integrated part of the strainer housing

FIG. 2 shows the schematic side view of a cell strainer with the vibrating device as a secondary part to be attached to the strainer

FIG. 3 shows the schematic side view of a cell strainer with the vibrating device ha

### DESCRIPTION OF THE INVENTION

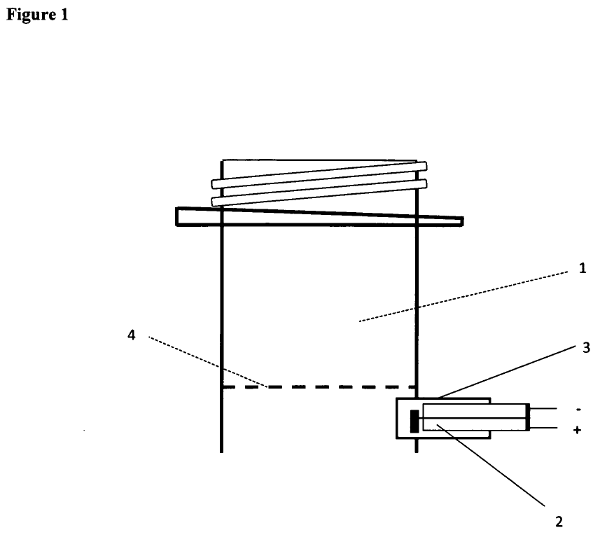

Filter devices (FIG. 1) basically consist of a plastic or metal housing (1) carrying the filter mesh or the membrane (4) can be integrated in the housing or be an exchangeable part of the device. According to the invention, the filter device is equipped with an eccentric rotating mass vibrating motor (2), the like of which is commonly used in massage equipment, warning devices, cell phones, etc. Amplitude and frequency of the vibration can be varied according to the specific needs by rotating mass and rotation speed. The low voltage motors are fueled by batteries, commonly used 3 V to 12 V or by a low power DC supply coming from a transformer or another battery-driven device like cell phones, laptops, tablets etc. The vibration frequency can be consistent or variable and regulated by the power supply.

One embodiment (FIG. 1) is that the eccentric rotating mass vibrating motor (2) is an integrated part of the filter/strainer device (1). The motor is permanently or temporarily placed in an opening of the filter housing (3). Vibration motor and filter housing should be tidily connected to allow the transfer of the mechanical energy to the filter/strainer unit to keep the woven mesh or membrane (4) in constant movement.

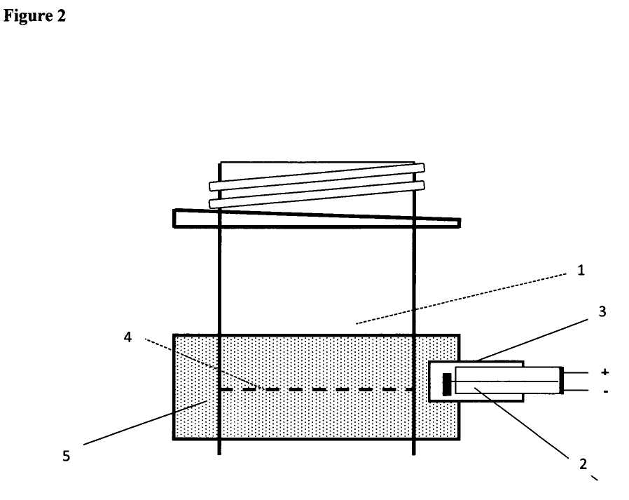

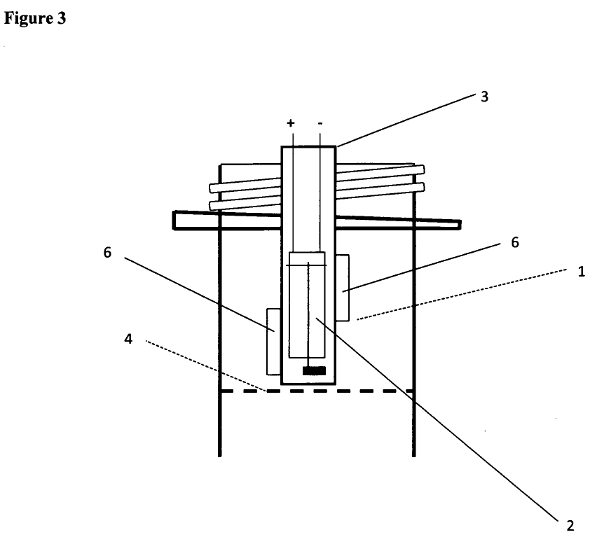

Other embodiments are to place the vibrating motor in auxiliary devices (FIGS. 2 and 3). This supplementary vibrating device can have all shapes which are complementary to the shape of the filter/strainer housing. One shape of the secondary vibrating device can be a ring (5) which enfolds the filter/strainer housing.

Another embodiment is to place the auxiliary device inside the filter/strainer housing, having direct contact with the liquid to be filtered (FIG. 3). The auxiliary device can be used to move the liquid inside the filter/strainer housing by giving the vibrating unit protrusions of a twisted form (6).

1. A vibrating research device to separate particles by their size by using a woven mesh or a pored membrane with defined openings.

2. A research device according to claim 1, wherein the vibration is caused by an eccentric rotating mass vibrating motor.

3. A research device according to claims 1 and 2, wherein the eccentric rotating mass vibrating motor is a built-in device of the separation device.

4. A research device according to claims 1 and 2, wherein the eccentric rotating mass vibrating motor is part of an auxiliary device which can be adjusted outside or inside of the strainer/filter.

5. A research device according to 4, wherein the auxiliary device located inside the strainer/filter has protrusions in a shape which creates a rotating movement of the liquid to be filtrated.
